(19) United States
(12) Patent Application Publication
(10) Pub. No.: US 2008/0091397 A1
(43) Pub. Date: Apr. 17, 2008

(54) Error models for location analysis data that robustly handles replicate data

(76) Inventor: Simon G. Handley, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/580,799

(22) Filed: Oct. 13, 2006

(51) Int. Cl. G06G 7/48

(52) U.S. Cl. 703/11

(57) ABSTRACT

A computer programmed to determine a standard error of a log ratio measurement of an immunoprecipitated sample and a whole cell extract at a particular feature is disclosed herein. A first quantity standing in known relation to the standard error of a signal intensity measurement corresponding to the immunoprecipitated sample at the particular feature is found. Also, a second quantity standing in known relation to the standard error of a signal intensity measurement corresponding to the whole cell extract at the particular feature is found. The standard error of the log ratio measurement of the immunoprecipitated sample and the whole cell extract sample is determined based upon said first and second quantities.

### BACKGROUND

DNA Microarrays are used to identify DNA sequences that are enriched in a biological sample. Depending on how this sample is prepared, identification of the sequences can provide measurements of biological events ranging from gene expression to chromatin structure. One such application is chromatin immunoprecipiatation, in which microarrays are used to determine locations in the genome that appear to be in physical contact with a protein that, for example, is regulating the expression of a gene.

Briefly, a DNA microarray may be embodied on a substrate that includes a plurality (typically thousands) of regions bearing particular chemical moities. Each region bearing a particular chemical moiety may be referred to as a “feature,” consisting of a quantity of “probes.” The chemical composition of each probe is chosen so as to include single-strand nucleotide sequences corresponding to a given location within the genome. In other words, a first feature may include single-strand nucleotide sequences of bases number one through sixty of a first chromosome, and a second feature may include single-strand nucleotide sequences of bases number sixty-one through one-hundred and twenty, and so on. Such an array is often referred to as a “tiling array.” The genomic regions represented by the various features on a tiling array may overlap, concatenate, or exhibit gaps. For example, a genomic gap of 200-300 base pairs may be exhibited from feature to feature. Although the recited example describes features including single-strand nucleotide sequences that are sixty bases in length, the features may be of other lengths.

A target single-strand nucleotide sequence (referred to herein as a “target”) known to correspond to a binding site of a transcription factor, or protein, or other activity of interest is hybridized with the array, and therefore commingles with the various probes thereon. (The target nucleotide sequence may have a protein bound to it.) Upon hybridization, the target binds to various probes on the array. Before hybridization, the targets are typically treated to tag the targets with dyes that fluoresce at a specific wavelength. After hybridization, a fluorescence reader, for example, may be used to measure the intensity of the signal emitted from the probes of each of the features, which represent the amount of target material hybridized to that probe. In other words, the reader obtains a signal strength corresponding to each feature on the array.

Typically, two different samples are prepared for hybridization with a microarray: (1) a control sample, known as a “whole cell extract,” which contains all the genetic material in a cell; and (2) an experimental sample, known as an “immunoprecipitated sample,” which contains an abundance of a particular protein of interest bound to various regions of a genome. Both the whole cell extract and the immunoprecipitated sample are permitted to hybridize with the features on the microarray. Consequently, the fluorescence reader measures two signal intensities for each feature: (1) the intensity of a signal at a first wavelength, which indicates the amount of binding between the probes of a given feature and a whole cell extract; and (2) the intensity of a signal at a second wavelength, which indicates the amount of binding between the probes of the aforementioned given feature and an immunoprecipitated sample. If, for a given feature, the intensity of the signal corresponding to the immunoprecipitated sample is substantially greater than the intensity of the signal corresponding to the whole cell extract, then the feature may be identified as indicating a possible genomic location of binding of a particular protein.

Given the aforementioned scheme, one issue to be addressed is the extent to which the intensity of the signal corresponding to the immunoprecipitated sample must exceed the intensity of the signal corresponding to the whole cell extract, in order to properly infer that the feature may identify a genomic location of binding. For example, it is common to analyze a microarray by finding the log ratio of the signals emanating from each feature:

log ratio=log₂[IP/WCE],

where IP represents the intensity of a signal corresponding to an immunoprecipitated sample at a given feature, and where WCE represents the intensity of a signal corresponding to a whole cell extract at the aforementioned given feature. Generally, the greater the log ratio exhibited at a specific feature, the more likely it is that the feature identifies the binding location for a given protein. To render the log ratio more meaningful, the log ratio may be adjusted to compensate for errors exhibited in the process of hybridizing the two samples and measuring their respective intensities. To allow for such adjustment, the standard error exhibited by the log ratio measurement at a given feature may be found:

σ_{log ratio}=|log ratio/X|,

where σ_{log ratio} represents the standard error exhibited by the log ratio measurement at a given feature, where X=(IP−WCE)/σ_{IP-WCE}, and where σ_{IP-WCE} represents the standard error exhibited at a given feature when finding the difference in signal strengths between the immunoprecipitated sample and the whole cell extract. This method of calculating the standard error is known as the “Rosettao method.”

Assuming that the standard error of the log ratio is calculated as described above, the calculated value becomes unstable as X approaches zero. (This problem relates to the fact that binary computing systems have difficulty in precisely performing calculations upon numbers of greatly different magnitude.) Unfortunately, throughout most of the features on the microarray, X approaches zero, because IP≈WCE. Moreover, this instability does not correspond to any physical phenomena seeming to militate such instability.

### SUMMARY

In general terms, this document is directed to a system and method for determining the standard error of a log ratio measurement.

According to one embodiment, a computerized method of determining standard error of a log ratio measurement of an immunoprecipitated sample and a whole cell extract at a particular feature includes calculating a first quantity standing in known relation to the standard error of a signal intensity measurement corresponding to the immunoprecipitated sample at the particular feature. Also, a second quantity standing in known relation to the standard error of a signal intensity measurement corresponding to the whole cell extract at the particular feature is calculated. The standard error of the log ratio measurement of the immunoprecipitated sample and the whole cell extract sample is calculated based upon said first and second quantities.

According to another embodiment, a computer is programmed to determine standard error of a log ratio measurement of an immunoprecipitated sample and a whole cell extract at a particular feature. The computer includes a processor and a memory in communication with the processor. The memory stores a set of instructions that, when executed, cause the processor to calculate a first quantity standing in known relation to the standard error of a signal intensity measurement corresponding to the immunoprecipitated sample at the particular feature. Also, the processor calculates a second quantity standing in known relation to the standard error of a signal intensity measurement corresponding to the whole cell extract at the particular feature. The processor also calculates the standard error of a log ratio measurement of the immunoprecipitated sample and the whole cell extract sample based upon said first and second quantities.

According to yet another embodiment, a computer-readable medium stores instructions that, when read and executed by a computer, cause the computer to calculate a first quantity standing in known relation to the standard error of a signal intensity measurement corresponding to the immunoprecipitated sample at the particular feature. Also, the computer calculates a second quantity standing in known relation to the standard error of a signal intensity measurement corresponding to the whole cell extract at the particular feature. The standard error of a log ratio measurement of the immunoprecipitated sample and the whole cell extract sample is calculated based upon said first and second quantities.

### BRIEF DESCRIPTION OF THE DRAWINGS

FIG. 1 depicts an exemplary embodiment of a computing environment for calculating a standard error.

FIG. 2 depicts an exemplary embodiment of a method of determining a standard error.

FIG. 3 depicts another exemplary embodiment of a method of determining a standard error.

### DETAILED DESCRIPTION

### Definitions

The term “gene” refers to a unit of hereditary information, which is a portion of DNA containing information required to determine a protein's amino acid sequence.

“Gene expression” refers to the level to which a gene is transcribed to form messenger RNA molecules, prior to protein synthesis.

“Gene expression analysis” refers to analysis methods used to understand the function and control of genes by determining the expression levels of nucleic acids (i.e. DNA or RNA) or proteins. For example, gene expression analysis is used for the identification of novel genes, the correlation of gene expression to a particular physiological condition, screening for disease predisposition, identifying the effect of a particular agent on cellular gene expression, etc., as described in U.S. Pat. No. 6,989,267, which is incorporated herein by reference.

A “microarray” or “DNA microarray” or “array” is a high-throughput hybridization technology that allows biologists to probe the activities of thousands of genes under diverse experimental conditions. Microarrays function by selective binding (hybridization) of probe DNA sequences on a microarray chip to fluorescently-tagged messenger RNA fragments from a biological sample. The amount of fluorescence detected at a probe position can be an indicator of the relative expression of the gene bound by that probe. Any given microarray may employ a single channel or single color platform on which only a single experiment is run, or a multi channel or multi color platform on which multiple experiments are run. A common multi channel example is a two channel platform where one experiment is color-coded with a first color (e.g., color-coded green) and the other channel is color-coded with a second color (e.g., color-coded red). Such an arrangement may be used to simultaneously run a reference sample (experiment) and a test sample (experiment) and differential expression values may be calculated from a comparison of the results.

“Chromosome” refers to a continuous, piece of DNA, which may contain many genes, regulatory elements, and other intervening nucleotide sequences.

“Protein expression” refers to the level, amount and time-course of one or more proteins in a particular cell, tissue or organism.

“Protein expression analysis” refers to methods for isolating, identifying, and/or quantifying proteins to determine their function and role in various physiological processes. Examples of protein expression analysis are described in Published U.S. patent application Nos. 20050233337 and 20040115722, which is hereby incorporated by reference.

“Location analysis” refers to analysis methods used to determine the locus (i.e. a fixed position in a genome) corresponding to a biological phenomenon of interest. An example of location analysis is described in U.S. Pat. No. 6,410,243, which is incorporated by reference herein.

“Comparative genomic hybridization” refers to a method of analysis of copy number changes (e.g., gains or losses) in the DNA content of a tissue of interest. Examples of comparative genomic hybridization are described in Published U.S. patent application Nos. 20050244881, 20050233339, and 20050233338, which are hereby incorporated by reference.

“Genomic location” or “location” refers to a base pair coordinate or range of base pair coordinates on a genome, and/or information sufficient to arrive at the aforementioned base pair coordinate or range of base pair coordinates.

“Standard error” of a given statistic refers to the estimated standard deviation of the given statistic.

### Embodiments

Various embodiments presented herein will be described in detail with reference to the drawings, wherein like reference numerals represent like parts and assemblies throughout the several views. Reference to various embodiments should not be construed as limiting the scope of covered subject matter, which is limited only by the scope of the claims attached hereto. Additionally, any examples set forth in this specification are not intended to be limiting and merely set forth some of the many possible embodiments.

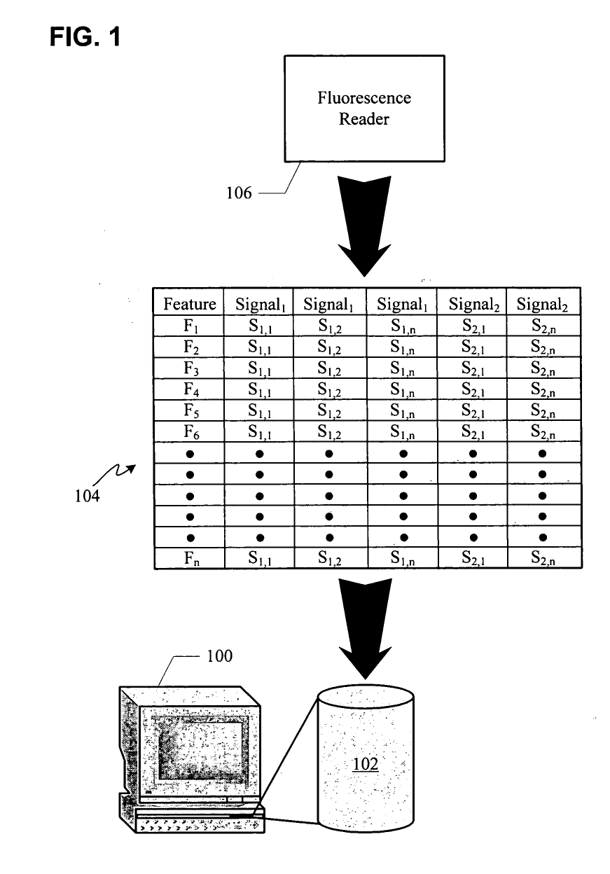

FIG. 1 depicts a computer 100 that is programmed to generate error models for location analysis data. The computer 100 includes the components typically found in a general-purpose computer, i.e., it includes a processor that is coupled to one or more stages of memory that store software and data. The processor communicates, via an input/output (I/O) bus, with various input, output, and communication devices, including a display, such as a monitor, a keyboard, a mouse, and/or speakers, to name a few such devices. Various peripheral devices may also communicate with the processor via the I/O bus, including a network interface card, a hard disc drive, or other mass data storage device, removable media drives, such as a CD ROM drive or a DVD drive (which may be both readable and writable), and/or a wireless interface. It is understood that computers presently employ many chip sets and architectures that are continuously evolving and are being improved. The computer 100 broadly represents all such chip sets and architectures, and the various embodiments of the user interface described herein may execute on all such chip sets and architectures. The computer 100 can have any suitable platform, such as a mainframe, desktop, portable, notebook, tablet, and handheld platform.

The processor in the computer 100 is able to access, either directly or indirectly, a data store 102. The data store 102 may be stored in a memory device(s) within the computer 100 or managed by the computer 100. For example, the data store 102 may be embodied within random access memory RAM chip(s) within the computer 100, or accessible to the computer 100 through a wired or wireless connection. Also, the data store 102 may be embodied within a mass storage device(s) within the computer 100. The data store 102 may be embodied on both the RAM chip(s) and mass storage device(s) within the computer 100. Further, the data store 102 may be embodied in a computing system, memory device, or network storage device, that is accessible to the computer 100 via a network, such as a local area network (LAN) that is coupled to the Internet, for example.

The data store 102 may be embodied as a database, such as a relational database or an object-oriented database, or a file or set of files. For example, the data store 102 may be embodied as a relational database, such as a SQL server executing either locally or on a remote computer accessible by the computer 100 via a network, or as an object-oriented database, such as an Objectivity server (again, executing either locally or on a remote computer). Alternatively, the data store 102 may be embodied as any other form of software unit fit for storing and providing access to data, such as location analysis data. The data store 102 may be embodied as a data file, such as a comma separated value (CSV) file, or other type of file, XML file, etc.

The data store 102 stores genomic data 104 that is accessible to the computer 100. The genomic data 104 may originate from any source. For the sake of illustration, the genomic data 104 is described herein as originating from a fluorescence reader 106. The fluorescence reader 106 may operate so as to obtain a quantity of n intensity readings for each wavelength (the wavelength corresponding to the whole cell extract, and the wavelength corresponding to the immunoprecipitated sample) at each feature on the microarray. Each of the n intensity readings for each wavelength/feature combination may be stored in the data store 102. As shown in FIG. 1, at feature F₁, for example, a quantity of n measurements {S_{1,1} . . . S_{1,n}} are obtained at a first wavelength, which may be assumed herein to correspond to the immunoprecipitated sample, and are stored in the data store 102. Similarly, at feature F₁, a quantity of n measurements {S_{2,1} . . . S_{2,n}} are obtained at a second wavelength, which may be assumed herein to correspond to the whole cell extract, and are stored in the data store 102. Thus, for each feature on a given microarray, a quantity of 2n measurements may be obtained. The quantity of measurements, n, may vary from application to application, and is a variable that is the proper subject of design choice. Generally speaking, the quantity of measurements, n, is chosen so as to yield reliable measurement results and average out noise in the measurements.

According to some embodiments of the present invention, the computer 100 is programmed to carry out the acts described with reference to the following figures. Alternatively, the acts may be carried out by a computer in communication with the computer 100 managing the data store 102. Further, the acts described with reference to the following figures may be carried out by hardware modules, such as by an application-specific integrated circuit (ASIC), by the cooperative efforts of an ASIC and a processor programmed to carry out some of the acts described with reference to the following figures, and/or by the cooperative efforts of two or more computers programmed to carry out the acts described with reference to the following figures. Also, the acts described with reference to the following figures may be stored on a computer-readable medium, such as a memory device, magnetic or optical storage medium, etc. For the sake of illustration only, the discussion herein is written as though the acts described with reference to the following figures are carried out by the computer 100 depicted in FIG. 1.

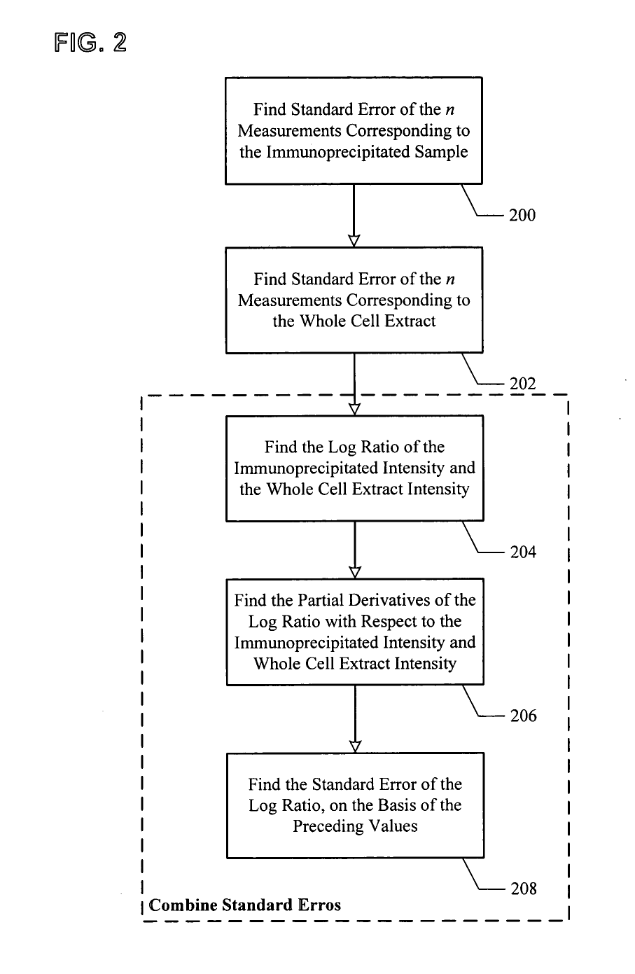

As shown with reference to FIG. 2, the computer 100 may initially caluculate the standard error of the n intensity measurements corresponding to the immunoprecipitated sample at a given feature (operation 200). The quantity found at operation 200 may be termed σ_{IP}. According to some embodiments, the n intensity measurements corresponding to the immunoprecipitated sample may be averaged, and that average may be used as a singular intensity value describing the level of binding between the particular feature and the immunoprecipitated sample. According to such an embodiment, the standard error, σ_{IP}, may be calculated as the standard deviation of the n intensity values at the wavelength corresponding to the immunoprecipitated sample divided by the square-root of n.

Similar to operation 200, the standard error of the n intensity measurements corresponding to the whole cell extract at the aforementioned given feature may be calulcated (operation 202). The quantity found at operation 202 may be termed σ_{WCE}. Again, according to some embodiments, the n intensity measurements corresponding to the whole cell extract may be averaged, and that average may be used as a singular intensity value describing the level of binding between the particular feature and the whole cell extract. According to such an embodiment, the standard error, σ_{WCE}, may be calculated as the standard deviation of the n intensity values at the wavelength corresponding to the whole cell extract divided by the square-root of n.

Operations 204, 206 and 208 cooperate to combine the standard errors of the intensity values of the immunoprecipitated sample and whole cell extract into a single standard error. Therefore, a dashed box surrounds operations 204-208, indicating that they perform a joint operation that may be accomplished in other ways (some of which are described below).

As shown in operation 204, the log ratio of the intensity of the signals corresponding to the immunoprecipitated sample and the whole cell extract is found. This value may be termed Q.

Q=log₂(IP/WCE),

where IP represents the intensity of the signal corresponding to the immunoprecipitated sample, and WCE represents the intensity of the signal corresponding to the whole cell extract.

Next, as shown in operation 206, the partial derivatives of Q are found with respect to both IP and to WCE. In other words, ∂Q/∂IP and ∂Q/∂WCE are found in operation 206.

Finally, in operation 208, the standard error of Q, σ_{Q}, is found based on the foregoing values:

$${σ}_{Q} = \sqrt{{( \frac{\partial Q}{\partial IP} \cdot {σ}_{IP} )}^{2} + {( \frac{\partial Q}{\partial WCE} \cdot {σ}_{WCE} )}^{2}} .$$

By expansion of the foregoing formula, and by simplification thereof, it follows that the computer 100 may also be programmed to find the standard error of Q, σ_{Q}, according to the following formula:

$${σ}_{Q} = \frac{1}{ln ( 2 )} \sqrt{{f}^{2} + {( \frac{{σ}_{IP , add}}{IP} )}^{2} + {f}^{2} + {( \frac{{σ}_{WCE , add}}{WCE} )}^{2}} ,$$

where σ_{IP,add} represents the additive error of the immunoprecipitated sample intensity values, σ_{WCE,add} represents the additive error of the whole cell extract intensity values, and where f is a coefficient describing the multiplicative error.

Observation of the foregoing formula reveals that it tends toward numerical instability when either IP or WCE approaches zero. Such a condition comports with physical reality, as the standard error of a variable that is quite small in extent is difficult to determine with certainty. Also, the foregoing technique avoids the problem of calculation of standard error using values of significantly different magnitudes for normative conditions, e.g., when IP≈WCE. “Values of significantly different magnitudes,” include numbers of sufficiently different magnitude that, when jointly operated upon by a computer, yields a mathematically imprecise result, or otherwise results in the introduction of significant error. For example, a very large number that is added to a very small number by a computer may result in an inaccurate result, because the floating point numbers must be converted into quantites having the same exponent prior to addition. The conversion process may result in loss of precision in the mantissas, as understood by those of ordinary skill in the art.

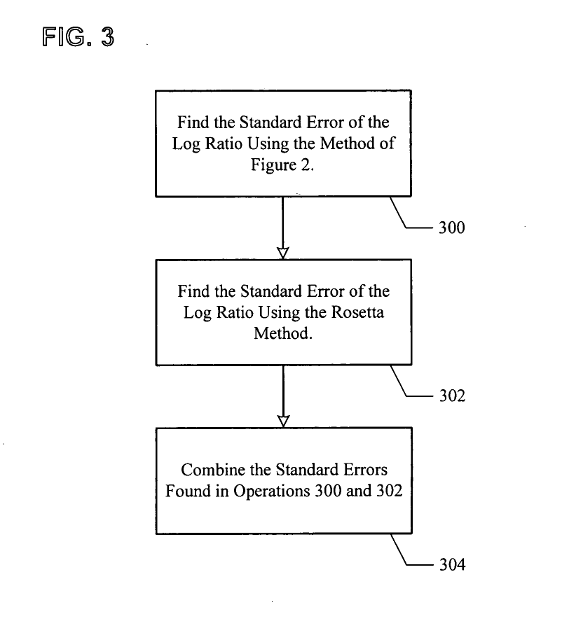

As shown in FIG. 3, according to some embodiments, the computer 100 may be programmed to find the standard error of Q, σ_{Q}, according to the method of FIG. 2 (operation 300). Also, the computer 100 may be programmed to find σ_{Q}, according to the Rosetta method, which was discussed in the Background section of this document (operation 302). Finally, as shown in operation 304, the two standard error values may be combined into a single such value. For example, the two standard error values may be averaged, or some other method of finding their central tendency may be employed to combine the two values into a single value. Alternatively, the two standard error values may be combined by employing a weighted averaging scheme, whereby the weights are assigned according to the values of WCE and IP, and the reliability of each method in light of those values. For example, the weight function may have its smallest value when a given method is least reliable, e.g., the weight function may yield a value of zero for the Rosetta method when IP=WCE, and may yield a value of zero for the method disclosed herein when IP or WCE is equal to zero. The weight function may increase towards one as the IP and/or WCE values grow different from the aforementioned values leading to a zero.

After calculation of the standard error, the standard error may be used to determine whether a particular feature indicates that a corresponding genomic location is a potential binding site for a given protein. For example, the log ratio may be scaled by the standard error, or otherwise manipulated thereby, and the scaled or manipulated log ratio may then be analyzed to determine if the feature indicates a potential binding site.

In addition to use of the log ratio to assess whether a feature indicates a potential site of binding, an “X value” may be calculated for each feature (a definition of the X value is presented in the Background section). According to the laws of combining standard errors, it follows that the standard error of a plurality of X values that have been averaged to arrive at a single X value for a given feature is:

σ_{Xavg}=1/n^{1/2},

where σ_{Xavg} represents the standard error of the average of a quantity of n X values corresponding to a given feature.

This aforementioned techniques for calculating standard error is useful in the context of analyzing and/or otherwise manipulating a single replicate data point. It is particularly useful in the analysis and/or manipulation of plural replicate data points, because it provides reliable standard error data for normalizing the various replicate data points prior to their analysis and/or manipulation. After calculation of the standard error as described herein, the signal intensity measurements and/or log ratios thereof, may be manipulated with the standard error (example: divided by the standard error) or otherwise assessed in light of the standard error, in order to determine whether a particular feature on a microarray potentially identifies a binding site.

Microarrays or arrays processed using the methods and structures disclosed herein find use in a variety of different applications, where such applications are generally analyte detection applications in which the presence of a particular analyte (i.e., target) in a given sample is detected at least qualitatively, if not quantitatively. Protocols for carrying out such assays are well known to those of skill in the art and need not be described in great detail here. Generally, the sample suspected of containing the analyte of interest is contacted with an array according to the subject methods and structures under conditions sufficient for the analyte to bind to its respective binding pair member (i.e., probe) that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface. Specific analyte detection applications of interest include, but are not limited to, hybridization assays in which nucleic acid arrays are employed.

In these assays, a sample to be contacted with an array may first be prepared, where preparation may include labeling of the targets with a detectable label, e.g. a member of signal producing system. Generally, such detectable labels include, but are not limited to, radioactive isotopes, fluorescers, chemiluminescers, enzymes, enzyme substrates, enzyme cofactors, enzyme inhibitors, dyes, metal ions, metal sols, ligands (e.g., biotin or haptens) and the like. Thus, at some time prior to the detection step, described below, any target analyte present in the initial sample contacted with the array may be labeled with a detectable label. Labeling can occur either prior to or following contact with the array. In other words, the analyte, e.g., nucleic acids, present in the fluid sample contacted with the array according to the subject methods and structures may be labeled prior to or after contact, e.g., hybridization, with the array. In some embodiments of the subject methods, the sample analytes e.g., nucleic acids, are directly labeled with a detectable label, wherein the label may be covalently or non-covalently attached to the nucleic acids of the sample. For example, in the case of nucleic acids, the nucleic acids, including the target nucleotide sequence, may be labeled with biotin, exposed to hybridization conditions, wherein the labeled target nucleotide sequence binds to an avidin-label or an avidin-generating species. In an alternative embodiment, the target analyte such as the target nucleotide sequence is indirectly labeled with a detectable label, wherein the label may be covalently or non-covalently attached to the target nucleotide sequence. For example, the label may be non-covalently attached to a linker group, which in turn is (i) covalently attached to the target nucleotide sequence, or (ii) comprises a sequence which is complementary to the target nucleotide sequence. In another example, the probes may be extended, after hybridization, using chain-extension technology or sandwich-assay technology to generate a detectable signal (see, e.g., U.S. Pat. No. 5,200,314).

In certain embodiments, the label is a fluorescent compound, i.e., capable of emitting radiation (visible or invisible) upon stimulation by radiation of a wavelength different from that of the emitted radiation, or through other manners of excitation, e.g. chemical or non-radiative energy transfer. The label may be a fluorescent dye. Usually, a target with a fluorescent label includes a fluorescent group covalently attached to a nucleic acid molecule capable of binding specifically to the complementary probe nucleotide sequence.

Following sample preparation (labeling, pre-amplification, etc.), the sample may be introduced to the array. The sample is contacted with the array under appropriate conditions using the subject methods and structures to form binding complexes on the surface of the substrate by the interaction of the surface-bound probe molecule and the complementary target molecule in the sample. The presence of target/probe complexes, e.g., hybridized complexes, may then be detected. In the case of hybridization assays, the sample is typically contacted with an array under stringent hybridization conditions, whereby complexes are formed between target nucleic acids that agent are complementary to probe sequences attached to the array surface, i.e., duplex nucleic acids are formed on the surface of the substrate by the interaction of the probe nucleic acid and its complement target nucleic acid present in the sample. A “stringent hybridization” and “stringent hybridization wash conditions” in the context of nucleic acid hybridization (e.g., as in array, Southern or Northern hybridizations) are sequence dependent, and are different under different experimental parameters.

The array is then incubated with the sample under appropriate array assay conditions, e.g., hybridization conditions, as mentioned above, where conditions may vary depending on the particular biopolymeric array and binding pair. Once incubation is complete, the array is typically washed at least one time to remove any unbound and non-specifically bound sample from the substrate; generally at least two wash cycles are used. Washing agents used in array assays are known in the art and, of course, may vary depending on the particular binding pair used in the particular assay. For example, in those embodiments employing nucleic acid hybridization, washing agents of interest include, but are not limited to, salt solutions such as sodium, sodium phosphate (SSP) and sodium, sodium chloride (SSC) and the like as is known in the art, at different concentrations and which may include some surfactant as well.

Following the washing procedure, the array may then be interrogated or read to detect any resultant surface bound binding pair or target/probe complexes, e.g., duplex nucleic acids, to obtain signal data related to the presence of the surface bound binding complexes, i.e., the label is detected using colorimetric, fluorimetric, chemiluminescent, bioluminescent means or other appropriate means. The obtained signal data from the reading may be in any convenient form, i.e., may be in raw form or may be in a processed form.

In using an array processed using the subject methods and structures set forth herein, the array typically is exposed to a sample (for example, a fluorescently labeled analyte, e.g., protein containing sample) and the array then read. Reading of the array to obtain signal data may be accomplished by illuminating the array and reading the location and intensity of resulting fluorescence (if such methodology was employed) at each feature of the array to obtain a result. For example, an array scanner may be used for this purpose that is similar to the Agilent MICROARRAY SCANNER available from Agilent Technologies, Palo Alto, Calif. Other suitable apparatus and methods for reading an array to obtain signal data are described in U.S. Pat. Nos. 6,756,202 and 6,406,849, the disclosures of which are herein incorporated by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583, the disclosure of which is herein incorporated by reference, and elsewhere).

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A computerized method of determining standard error of a log ratio measurement of an immunoprecipitated sample and a whole cell extract at a particular feature of a microarray, the method comprising:
measuring a plurality of signal intensities corresponding to the immunoprecipitated sample at the particular feature of the microarray;
measuring a plurality of signal intensities corresponding to the whole cell extract sample at the particular feature of the microarray;
calculating a first quantity standing in known relation to the standard error of the signal intensity measurements corresponding to the immunoprecipitated sample at the particular feature;
calculating a second quantity standing in known relation to the standard error of the signal intensity measurements corresponding to the whole cell extract at the particular feature; and
calculating the standard error of the log ratio measurement of the immunoprecipitated sample and the whole cell extract sample based upon said first and second quantities.

2. The method of claim 1, further comprising:
using the standard error and the log ratio measurement to determine if the particular feature potentially identifies a binding site for a protein.

3. The method of claim 1, further comprising:
calculating the standard error of the log ratio measurement of the immunoprecipitated sample and the whole cell extract sample using the Rosetta method.

4. The method of claim 3, further comprising:
combining the standard error that was calculated as a function of the first and second quantities with the standard error that was calculated using the Rosetta method.

5. The method of claim 4, wherein the act of combining standard errors comprises combining the standard errors by averaging the standard errors.

6. The method of claim 4, wherein the act of combining standard errors comprises combining the standard errors by weighted averaging of the standard errors.

7. The method of claim 1, wherein the standard error of the log ratio measurement of the immunoprecipitated sample and the whole cell extract sample is calculated without finding the difference between the signal intensity measurement corresponding to the immunoprecipitated sample and the signal intensity measurement corresponding to the whole cell extract.

8. The method of claim 1, wherein the act of calculating the standard error is carried out such that operations are not carried out upon values having significantly different magnitudes when the signal intensity measurement corresponding to the immunoprecipitated sample approaches the signal intensity measurement corresponding to the whole cell extract.

9. A computer programmed to determine standard error of a log ratio measurement of an immunoprecipitated sample and a whole cell extract at a particular feature, the computer comprising:
a processor; and
a memory in communication with the processor, the memory storing a set of instructions that, when executed, cause the processor to
calculate a first quantity standing in known relation to the standard error of a signal intensity measurement corresponding to the immunoprecipitated sample at the particular feature;
calculate a second quantity standing in known relation to the standard error of a signal intensity measurement corresponding to the whole cell extract at the particular feature; and
determine the standard error of a log ratio measurement of the immunoprecipitated sample and the whole cell extract sample based upon said first and second quantities.

10. The computer of claim 9, wherein the memory further stores instructions that when executed cause the processor to use the standard error and the log ratio calculation to determine if a feature potentially identifies a binding site for a protein.

11. The computer of claim 9, wherein the memory further stores instructions that when executed cause the processor to calculate the standard error of the log ratio measurement of the immunoprecipitated sample and the whole cell extract sample using the Rosetta method.

12. The computer of claim 11, wherein the memory further stores instructions that when executed cause the processor to combine the standard error that was calculated as a function of the first and second quantities with the standard error that was calculated using the Rosetta method.

13. The computer of claim 12, wherein the memory stores instructions that when executed cause the processor to combine standard errors by averaging the standard errors.

14. The computer of claim 12, wherein the memory stores instructions that when executed cause the processor to combine standard errors by weighted averaging of the standard errors.

15. The computer of claim 9, wherein the memory stores instructions that when executed cause the processor to calculate standard error of the log ratio measurement of the immunoprecipitated sample and the whole cell extract sample without finding the difference between the signal intensity measurement corresponding to the immunoprecipitated sample and the signal intensity measurement corresponding to the whole cell extract.

16. A computer-readable medium storing instructions that, when read and executed by a computer, cause the computer to:
calculate a first quantity standing in known relation to the standard error of a signal intensity measurement corresponding to the immunoprecipitated sample at the particular feature;
calculate a second quantity standing in known relation to the standard error of a signal intensity measurement corresponding to the whole cell extract at the particular feature; and
calculate the standard error of a log ratio measurement of the immunoprecipitated sample and the whole cell extract sample based upon said first and second quantities.

17. The computer-readable medium of claim 16, wherein the computer-readable medium further stores instructions that when executed cause the computer to use the standard error and the log ratio measurement to determine if a feature potentially identifies a binding site for a protein.

18. The computer-readable medium of claim 15, wherein the computer-readable medium further stores instructions that when executed cause the computer to calculate the standard error of the log ratio measurement of the immunoprecipitated sample and the whole cell extract sample using the Rosetta method.

19. The computer-readable medium of claim 18, wherein the computer-readable medium further stores instructions that when executed cause the computer to calulculate standard error of the log ratio measurement of the immunoprecipitated sample and the whole cell extract sample without finding the difference between the signal intensity measurement corresponding to the immunoprecipitated sample and the signal intensity measurement corresponding to the whole cell extract.

20. The computer-readable medium of claim 16, wherein the instructions for calculating the standard error are structured such that operations are not carried out upon values having significantly different magnitudes when the signal intensity measurement corresponding to the immunoprecipitated sample approaches the signal intensity measurement corresponding to the whole cell extract.
